(19) United States
(12) Patent Application Publication
(10) Pub. No.: US 2010/0021589 A1
(43) Pub. Date: Jan. 28, 2010

(54) OIL BLEND OF SYNERGISTICALLY LOW OXIDATION VALUE

(75) Inventors: Jacob LASKOV, Jerusalem (IL); Danny DIZER, Jerusalem (IL)

Correspondence Address: LOWE HAUPTMAN HAM & BERNER, LLP, 1700 DIAGONAL ROAD, SUITE 300, ALEXANDRIA, VA, 22314, US

(73) Assignee: SHEMEN INDUSTRIES LTD., Haifa (IL)

(21) Appl. No.: 12/353,874

(22) Filed: Jan. 14, 2009

Related U.S. Application Data
(60) Provisional application No. 61/083,435, filed on Jul. 24, 2008.

(51) Int. Cl. C11B 5/00; A23D 9/00; A23L 1/303

(52) U.S. Cl. 426/73; 426/546; 426/601; 426/417; 426/72

(57) ABSTRACT

Cost saving edible oil blends of plant or vegetable source comprising a low percentage by weight of at least one high oleic acid oil, a complementary high percentage by weight of at least one non- high oleic acid oil and antioxidant additives in an amount that does not affect organoleptic quality, the oil blends presenting a highly effective synergistic oxidation hindering effect at frying conditions.

### FIELD OF THE INVENTION

The present invention generally pertains to oil blends characterized by synergistically low oxidation value and to method for their production.

### BACKGROUND OF THE INVENTION

This invention relates to the field of edible oils, especially edible oils for home use and for the food industry as ingredients in fried, baked or cooked food products and frying oils for room temperature stored fried food products such as snacks. The basic requirements for frying fat and oil are heat stability and oxidation stability. Additional requirements are that it should be cost-effective, have acceptable taste, be processable (e.g., flowable at ambient temperature) and organoleptically acceptable.

In the past, emphasis was placed on adopting a low-fat diet because such a diet had been shown to effectively reduce total and LDL cholesterol. However, low-fat diets may lead to reductions in HDL-cholesterol and increases in triacylglycerol concentrations. More recently, research suggests that the type of dietary fat, more than total fat, affects cardiovascular disease (CVD) risk. In fact, the Nurses' Health Study, estimated that replacing 5% of calories from saturated fatty acids or 2% of calories from trans fats with equivalent portions of polyunsaturated fatty acids (PUFAS) would significantly reduce CVD risk.

Palm oil, which has high oxidation stability, has frequently been used as frying fat and oil. It is also known in the art to use the palm oil fraction called palmolein for commercial frying. This edible oil of vegetable source has a saturated fatty acid content of about 40% resulting in a high value of oxidation stability which in turn increases its storage stability. Palmolein has been shown to resist rancidity for 18-24 hours when exposed to a stream of air blown through the sample at a rate of 20 liter per hour and a temperature of 110° C. under Rancimat test sensitivity of 200 μS.

An example of an improved frying fat and oil derived from palm can be found in European patent EP0797921, which provides frying fat and oil comprising a fat and oil composition derived from palm oil or from a mixture of palm oil and a liquid vegetable oil. The fat and oil composition comprises 25 to 48% by weight of saturated fatty acid residues and 40 to 60% by weight of monounsaturated fatty acid residues based on the total fatty acid residue content, the total dipalmitoyl-monooleoyl glycerides of which have a PPO/POP ratio of not less than 0.5.

Saturated fatty acids such as acetic, propionic, butyric, valeric, hexanoic, caprylic, decanoic, lauric, myristic, palmitic, heptadecanoic, stearic, arachidic, behenic or lignoceric have the drawback of being either organoleptically unacceptable or unhealthy as dietary fat and unhealthy for use as frying oils, and it is thus desirable to find a method for improving the oxidation stability of vegetable oils such as canola, sunflower, and soy oils that have a much lower saturated fatty acid content and also have the advantage of being free of partially hydrogenated fatty acids.

The oxidation stability of liquid comprising oils derived from plant materials is determined by using the Rancimat Test (ISO 6886, pr EN 14112). In the Rancimat Test, samples of oil liquid are aged at a constant temperature (e.g., 110° C.) while air is passed through the liquid at a predetermined rate (e.g., 20 litres/hour). The exhaust airflow passes through a measuring cell filled with distilled water. The conductivity of the measuring cell is measured continuously and recorded automatically. As the liquid oxidizes, volatile organic acids are produced and taken up by the distilled water, increasing its conductivity. The oxidation process is such that there is a gradual increase in measured conductivity followed by a rapid increase. The length of the period prior to the rapid increase, known as the ‘induction period’ is a measure of the oxidation stability of the oil being tested. The presence in the oil of an effective anti-oxidant will lengthen the induction period.

Vegetable oils such as such as canola, sunflower and soy oils, have a low saturated fatty acid content, but are also relatively unstable to oxidation, typically 5 to 7 hours in a Rancimat test, but as long as around 12 hours if natural antioxidants have been added. However the applicability of this effect is limited by the fact that even with a dramatic increase of natural antioxidants up to 1% w/w, a 20 hour resistance value in the Rancimat test could not be achieved, whereas the resistance value of Palmolein is 18-24 hours. It should be pointed out that a 1% percentage per weight of antioxidants seriously affects product taste.

Soybean distillate is not considered to be suitable for use as a frying oil because of its low content in tocopherols and the creation of toxic secondary lipid peroxidation products due to thermal oxidation.

Examples of antioxidants that can be added to increase the stability of vegetable oils are β-carotene, phenols, tocopherols etc. Another antioxidant that is commonly used is rosmarinic acid, a natural polyphenol antioxidant carboxylic acid found in many Lamiaceae herbs such as rosemary, oregano, sage, thyme and peppermint. Rosmarinic acid may be obtained from rosemary extracts, which contain a large number of additional compounds including camosic acid and carnosol.

While classic sunflower oil (approximately 40% oleic acid) is not considered a high oleic acid oil, new hybrid sunflower varieties produce high oleic sunflower oil which can contain more than 80% oleic acid. High oleic acid oil is very expensive, however.

Therefore there is still a long felt need for an all-natural, cost effective and organoleptic acceptable frying oil with improved oxidation stability which is free of synthetic antioxidants, lauric acid, trans fats, and cholesterol; is low in saturated fat; and is in low-viscosity liquid form at room temperature.

### SUMMARY OF THE INVENTION

It is one object of the invention to disclose an edible oil blend of improved oxidation stability. This oil blend comprises, inter alia, a mixture of at least one high oleic acid oil, (hereinafter—HOA) and at least one non-high oleic acid oil, (hereinafter—nHOA), both of vegetable source, up to about 99.98% weight percentage of total blend, and a supplement of antioxidants of plant origin, up to about 0.8%, e.g., 0.2 to 0.6% (weight percentages of total blend). Moreover, this edible oil blend is free (in most embodiments) of synthetic antioxidants, lauric acid, trans fatty acids, cholesterol. It comprises low content of saturate fat and it is provided commercially in a flowing liquid form.

Another object of the invention is to disclose an edible oil blend of improved oxidation stability that comprises, inter alia, a mixture of at least one high oleic acid oil, said high oleic acid oil comprising by weight percentage above 70% oleic acid and at least one non-high oleic acid oil.

Another object of the invention is to disclose edible oil blends wherein the antioxidant supplement comprising water-immiscible ingredients is selected from a group consisting at least one isomer of tocopherol, sterols, squalene, monoglycerides, non-glycerid esters of fatty acids and Rosemarin extract.

It is according to one specific embodiment of the present invention, wherein the aforesaid blend is being essentially free of oils that are derived from palm, Palmolein and/or fractions thereof.

It is according to another embodiment of the present invention, wherein the term ‘Rosmarin extract’ refers to a composition comprising at least one of the following ingredients: rosmarin extract, water soluble rosmarinic acid, water immiscible camosic acid, or any mixtures thereof.

Another object of the invention is to disclose edible oil blends as defined above, wherein the HOA to the nHOA weight ratio is ranging from 40:60 to 10:90, preferably 20:80 (w/w).

Another object of the invention is to disclose edible oil blends as defined above, wherein the oil blend is further consisting of at least one of the following isomers: α-Tocopherol, 2×10⁻³-1×10⁻¹%; β+γ-Tocopherol, 0.4×10⁻²-1.5×10⁻¹%; and, δ-Tocopherol, 0.35×10⁻²-1.4×10⁻¹%; Sterols 0.5×10⁻²-2×10⁻¹%; squalenes, 3×10⁻⁴-8×10⁻²; monoglycerides, 3×10⁻³-1.5×10⁻¹; non-glycerid esters of fatty acids about 2×10⁻²-0.9%; and, Rosemary extract 0.7×10⁻²-3×10⁻¹%.

It is according to another specific embodiment of the present invention, wherein the aforesaid blend comprises HOA-nHOA mixtures, up to about 98.5%; and a supplement of antioxidants of plant origin, up to about 1.5%. Hence for example, and in a non-limiting manner, the aforesaid supplement of antioxidants may be further processed, e.g., refined or deodorized, and/or comprised of poly-phenols of predetermined compositions and concentrations such that the organoleptic acceptance of the supplement is facilitated.

It is according to another specific embodiment of the present invention, wherein the aforesaid blend further comprises food additives. The food additives are selected in a non-limiting manner from a group consisting of propylene glycol; triacetine; carotenes, especially β-carotente; vitamin A and retinols, glutamine; flavor and fragrance compositions; surfactants, such as food-grade commercially available Tween™ products, non-ionic, anionic, cationic or zwitterionic surfactants or any mixture thereof.

Another object of the invention is to disclose edible oil blends as defined above, wherein the oil blend is characterized by an induction time of more than 20 hours as determined by the Rancimat Test (ISO 6886) at 110° C., air flow of 20 LH⁻¹, and a conductivity range of 200 μS.

Another object of the invention is to disclose edible oil blends as defined above, wherein the at least one HOA is selected in a non-limiting manner from a group consisting of high oleic soya oil , high oleic rapeseed oil, high oleic safflower oil and any other high oleic oils from high oleic varieties of vegetables or plants or other oils of vegetable or plant origin naturally containing at least 70% oleic acid or any mixtures thereof.

Another object of the invention is to disclose edible oil blends as defined above, wherein the non-HOA is edible oil of vegetable source, suitable for human or animal ingestion, said oil comprising saturated fatty acids selected in a non-limiting manner from a group of isopropanoic, butanoic, isobutanoic, pentanoic, isopentanoic, neopentanoic, isohexanoic, 2-ethylbutanoic, heptanoic, 2-methylhexanoic, isoheptanoic, neoheptanoic, octanoic, isooctanoic, 2-ethylhexanoic, nonanoic, isononanoic, 3,5,5,-trimethylhexanoic, decanoic, isodecanoic, neodecanoic, myristic, margaric, stearic, isostearic, linoleic, linolenic, nonadecanoic, erucic, behenic acids and mixtures thereof; dicarboxylic acids selected from succinic, glutaric, adipic, sebacic, phthalic, isophthalic and terephthalic acids, isomers thereof and/or any mixtures thereof. Alternatively or additionally, at least a portion of the nHOAs are comprising mono unsaturated acids (MUFA)s, selected in a non-limiting manner from a group of palmitoleic acid, cis-vaccenic acid, and oleic acid. Alternatively or additionally, at least a portion of the nHOAs are oils comprising polyunsaturated fatty acids (PUFAs), selected in a non-limiting manner from a group of Omega-3 fatty acids, such as alpha-linolenic acid, Stearidonic acid, Eicosatrienoic acid, Eicosapentaenoic, Eicosapentaenoic acid, Docosapentaenoic acid, Tetracosapentaenoic acid, Tetracosahexaenoic acid etc., Omega-6 fatty acids such as Linoleic acid, Gamma-linolenic acid, Eicosadienoic acid, Dihomo-gamma-linolenic acid, Arachidonic acid, Docosadienoic acid, Adrenic acid, Docosapentaenoic acid etc., and/or Omega-9 fatty acids e.g., monosaturated acids, such as Eicosenoic acid, Erucic acid, Nervonic acid etc., polyunstaurated acids such as Mead acid etc.

Another object of the invention is to disclose edible oil blends as defined above, wherein the at least one isomer of Tocopherol is selected in a non-limiting manner from a group consisting of α-Tocopherol, β-Tocopherol, γ-Tocopherol, δ-Tocopherol, α-Tocotrienol, β-Tocotrienol, γ-Tocotrienol, δ-Tocotrienol, or any mixtures thereof.

Another object of the invention is to disclose edible oil blends as defined above, wherein the sterols are phytosterols selected in a non-limiting manner from a group consisting of α-sitosterol, γ-sitosterol, β-sitosterol, campesterol, stigmasterol, brassicasterol, spinosterol, taraxasterol, desmosterol, chalinosterol, poriferasterol, c\ddot{υ}onasterol, ergosterol, Δ-5 avenosterol, campesterol Δ-5-campesteroi, cierosterol, Δ-5-stigmasterol, Δ-7, 25-stigmadienol, Δ-7-avenosterol, Δ-7-β-sitosterol, brassicasterol, Δ-7-brassicasterol or any mixtures thereof.

Another object of the invention is to disclose edible oil blends as defined above, wherein the Squalene is 2,6,10,15,19,23-hexamethyl-tetracosahex-2,6,10,14,18,22-ene or any derivative thereof.

Another object of the invention is to disclose edible oil blends as defined above, wherein the monoglycerides are monoacylglycerol is consisting of one fatty acid chain of vegetable or plant origin. It is in the scope of the invention wherein the monoacylglycerol is monoglyceride citrate (i.e., MGC). It is also in the scope of the invention wherein the monoglycerides are admixed with diglycerides. The Monoglycerides and/or monoglycerides-diglycerides mixtures may be at least partially made from edible refined sunflower oil.

Another object of the invention is to disclose an edible oil blend as defined above, being propyl gallate-free and/or ascorbyl palmitate-free oil.

Another object of the invention is to disclose low saturated edible frying oil blends characterized by high induction time of more than 20 hours according to the Rancimat Test ISO 6886.

Another object of the invention is to disclose a method of increasing the induction time of oils, especially yet not exclusively, frying or baking oils. The method comprises steps of obtaining a mixture up to about 99.98% (weight percentage of final product) of the edible oil blend comprising: at least one high oleic acid oil (HOA) of vegetable source; and, at least one non-high oleic acid oil (nHOA) of vegetable source, wherein the HOA and nHOA are admixed in a weight ratio ranging from 10:90 to 30:70, preferably 20:80; and, admixing an antioxidants supplement, up to about 0.8%.

Another object of the invention is to disclose a method as defined above, wherein the step of admixing said supplement comprises a step or steps of admixing water-immiscible ingredients selected from a group consisting at least one isomer of tocopherol, sterols, squalene, monoglycerides, non-glycerid esters of fatty acids and Rosmarin extract or carnosic acid; thereby increasing the induction time of oils to more than 20 hours as determined by the Rancimat Test.

Another object of the invention is to disclose edible oil blends as defined above, wherein the at least one HOA is selected in a non-limiting manner from a group consisting of high oleic soya oil, high oleic rapeseed oil, high oleic safflower oil, and any other high oleic oils from high oleic varieties of vegetables or plants or other oils of vegetable or plant origin naturally containing at least 70% oleic acid or any mixtures thereof.

Another object of the invention is to disclose a method as defined above, additionally comprising step of selecting the non-HOA to be suitable for human or animal ingestion, especially organoleptically acceptable edible oil comprising saturated fatty acids selected in a non-limiting manner from a group of isopropanoic, butanoic, isobutanoic, pentanoic, isopentanoic, neopentanoic, isohexanoic, 2-ethylbutanoic, heptanoic, 2-methylhexanoic, isoheptanoic, neoheptanoic, octanoic, isooctanoic, 2-ethylhexanoic, nonanoic, isononanoic, 3,5,5,-trimethylhexanoic, decanoic, isodecanoic, neodecanoic, myristic, margaric, stearic, isostearic, linoleic, linolenic, nonadecanoic, erucic, behenic acids and mixtures thereof, dicarboxylic acids selected from succinic, glutaric, adipic, sebacic, phthalic, isophthalic and terephthalic acids, isomers thereof and/or any mixtures thereof. Alternatively or additionally, at least a portion of the nHOAs are oils comprising mono unsaturated acids (MUFA), selected in a non-limiting manner from a group of palmitoleic acid, cis-vaccenic acid, and oleic acid. Alternatively or additionally, at least a portion of the non-HOAs are oils comprising polyunsaturated fatty acids (PUFAs), selected in a non-limiting manner from a group of Omega-3 fatty acids, such as Alpha-linolenic acid, Stearidonic acid, Eicosatrienoic acid, Eicosapentaenoic, Eicosapentaenoic acid, Docosapentaenoic acid, Tetracosapentaenoic acid, Tetracosahexaenoic acid etc., Omega-6 fatty acids such as Linoleic acid, Gamma-linolenic acid, Eicosadienoic acid, Dihomo-gamma-linolenic acid, Arachidonic acid, Docosadienoic acid, Adrenic acid, Docosapentaenoic acid etc., and/or Omega-9 fatty acids e.g., monosaturated acids, such as Eicosenoic acid, Erucic acid, Nervonic acid etc., and polyunstaurated acids such as Mead acid etc.

Another object of the invention is to disclose a method as defined above, additionally comprising step of selecting the at least one isomer of Tocopherol from a group consisting of α-Tocopherol, β-Tocopherol, γ-Tocopherol, δ-Tocopherol, α-Tocotrienol, β-Tocotrienol, γ-Tocotrienol, δ-Tocotrienol, or any mixtures thereof.

Another object of the invention is to disclose a method as defined above, additionally comprising step of selecting the Sterols to be phytosterols selected from a group consisting of α-sitosterol, γ-sitosterol, β-sitosterol, campesterol, stigmasterol, brassicasterol, spinosterol, taraxasterol, desmosterol, chalinosterol, poriferasterol, c\ddot{υ}onasterol, ergosterol, Δ-5 avenosterol, campesterol Δ-5-campesteroi, cierosterol, Δ-5-stigmasterol, Δ-7, 25-stigmadienol, Δ-7-avenosterol, Δ-7-β-sitosterol, brassicasterol, Δ-7-brassicasterol or any mixtures thereof.

Another object of the invention is to disclose a method as defined above, additionally comprising step of selecting the squalene to be 2,6,10,15,19,23-hexamethyl-tetracosahex-2,6,10,14,18,22-ene or derivative thereof.

Another object of the invention is to disclose a method as defined above, additionally comprising step of selecting the monoglycerides to be monoacylglycerol consisting of one fatty acid chain of vegetable or plant origin. Additionally or alternatively, the method may comprise step of selecting the monoglycerides to be mixtures of monoglycerides and diglycerides. Similarly, the method may comprise step of selecting the monoglycerides mixtures to be at least partially made from edible refined sunflower oil.

Another object of the invention is to disclose a method as defined above, additionally comprising steps of (c) selecting at least one composition from a group consisting of propylene glycol, triacetine, carotenes, especially β-carotente, vitamin A, glutamine, flavor and fragrance compositions, surfactants or any mixtures thereof; and (d) admixing the selected food additive to the oil blend.

### BRIEF DESCRIPTION OF THE DRAWINGS

FIG. 1 is a diagram presenting the curve of Rancimat induction time against concentration of antioxidant additives in an oil blend according to the invention

FIG. 2 is a diagram presenting the synergistic effect of the oil blends as defined in the present invention

FIG. 3 is a diagram showing the highly effective oxidation-hindering effect of the oil blends as defined in the present invention

### DETAILED DESCRIPTION OF PREFERRED EMBODIMENTS

The following description is provided in order to enable any person skilled in the art to make use of the invention and sets forth the best modes contemplated by the inventor of carrying out this invention. Various modifications, however, will remain apparent to those skilled in the art, since the generic principles of the present invention have been defined specifically to provide the invention as defined below.

The term “about” refers hereinafter to a range of 25% below or above the referred value.

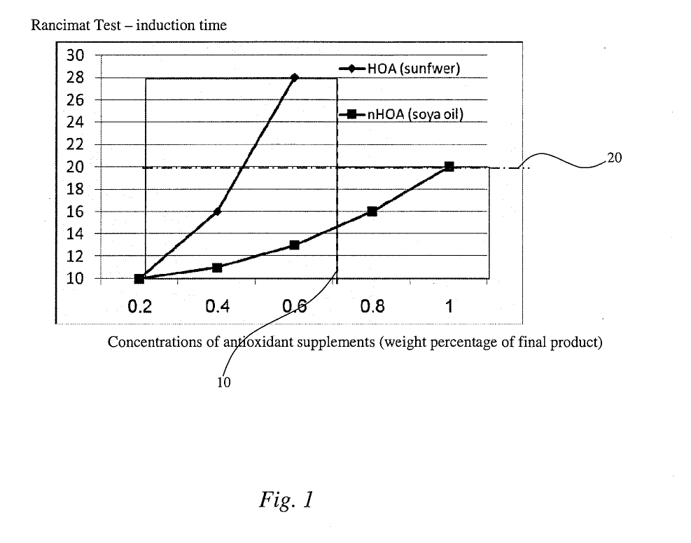

Reference is now made to FIG. 1, presenting the oxidation-hindering effect of water immiscible supplements with different concentrations of antioxidants on either HOA-blends or nHOA-control compositions. Two sets of HOA-nHOA blends and nHOA-control compositions were prepared and tested: A test according to ISO 6886 was commenced to determine the stability toward oxidation of the aforesaid two sets of oil blends.

A stream of air was blown through the samples (20 L/h) with the temperature of the heating system set at 110° C.; the conductivity range was set to 200 μS. An organoleptic test to evaluate sensational (taste, smell and appearance) characteristics of the sets of oil blends was also conducted.

In this experiment, each HOA-nHOA blend comprises a predetermined portion of high oleic acid canola oil (HOAC), about 20% (all weight percentages hereinafter are calculated from final product); and a predetermined portion of non high oleic acid oil of soybean-origin (nHOASB), about 80%. The overall concentration of the HOAC-nHOASB blend in the final oil blend is 99.0-99.98%.

In addition, each blend comprises a predetermined portion of water immiscible antioxidant supplement, comprising up to about 0.8%, e.g., 0.2% to 0.6.0% of the final oil blend, respectively. Each of the aforesaid supplements consists of a mixture of isomers of tocopherol, namely α-tocopherol, about 4.0×10⁻³-2.1×10⁻²%; β+γ-tocopherol, about 1.2×10⁻²-6.1×10⁻²%; and, δ-Tocopherol, about 1.0×10⁻²-4.8×10⁻²%; Sterols, about 1.5×10⁻²-7.6×10⁻²%; squalenes, about 0.5×10⁻³-2.4×10⁻²%; monoglycerides, about 8.8×10⁻³-4.4×10⁻²%; non-glyceride esters of fatty acids about 8×10⁻²-0.4%; Rosemary extract, about 2.0×10⁻²-1×10⁻¹%.

Those HOAC-nHOASB oil blends are characterized by: appearance of light transparent yellow fluid liquid; peroxide index of 1.1 meq O₂/kg oil; acidity 0.26°, specific gravity of about 0.913 g cm⁻³, and viscosity of about 120 cP. Peroxide index determination is performed by the standard UNE 55.023 of Rationalization Work Institute. Each of the nHOASB control blends consists of about 99.0 to 99.98% (by weight in the final product) of a soybean-origin polyunsaturated fatty acid and up to 0.8%, e.g., about 0.1 to 0.6% of water immiscible antioxidation supplements as defined above. The nHOASB blends are characterized by specific gravity of about 0.917 g cm⁻³, and viscosity of about 130 cP.

The vertical dashed line 10 in FIG. 1 symbolizes the upper limit of organoleptic acceptability of the water immiscible antioxidant supplements. The left colored box defines conditions for organoleptically acceptable oil blends, while the right colored box delimits organoleptically unacceptable blends. As shown by organoleptic line 10, the upper organoleptically acceptable limit for the concentration of the supplements is 0.6% (weight percentage of final product). Whereas NHOASB control blends show relatively low induction time at the upper limit value of 0.6% supplements, namely about 13 hours, HOAC-nHOASB oil blends showed a very high synergistic oxidation stability of about 28 hours at the same upper limit value of 0.6% supplements.

Horizontal dashed line 20 symbolizes a desirable target for commercial oil blends to be stable for oxidation for more than 20 hours. For the previously disclosed HOAC—oil blends, an organoleptically acceptable supplement concentration of about 0.475% enables the required 20 or more hours of stability. Nevertheless, a 1% supplement concentration (twice the acceptable amount) is required for the nHOASB control blends to achieve the desirable industrial goal of 20 hours stability.

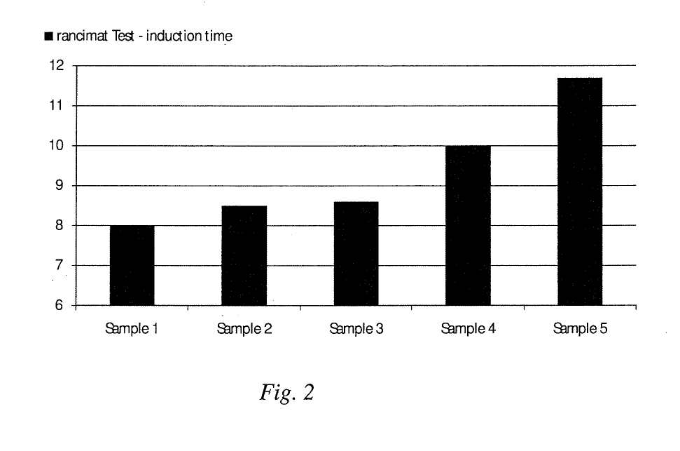

Reference is now made to FIG. 2, showing a significant oxidation-hindering effect of the oil blends as defined in the present invention. Five sets of HOA-blends were prepared and tested to determine their stability to oxidation as defined above.

Sample 1 is a blend of HOAC and nHOASB, 20:80% (all weight percentages hereinafter are calculated from final product); Sample 2 is a similar blend of HOAC and nHOASB, 20:80 with about 0.07% tocopherol blend; Sample 3 is a similar blend of HOAC and nHOASB, 20:80 with about 0.13% tocopherol blend; Sample 4 is a similar blend of HOAC and nHOASB, 20:80 with about 0.07% tocopherol blend comprising a α-tocopherol, about 1.4×10⁻²%; β+γ-tocopherol, about 1.8×10⁻²%; and, δ-Tocopherol, about 3.4×10⁻²%; sterols, about 5.25×10⁻²%; squalenes, about 1.75×10⁻³%; monoglycerides, about 2.7×10⁻²%; non-glyceride esters of fatty acids about 2.8×10⁻¹%; and, Sample 5 is a similar blend of HOAC and nHOASB, 20:80 with about 0.13% tocopherol blend comprising a α-tocopherol, about 2.6×10⁻²%; β+γ-tocopherol, about 3.3×10⁻²%; and, δ-tocopherol, about 6.4×10⁻²%; sterols, about 9.75×10⁻²%; squalenes, about 3.25×10⁻³%; monoglycerides, about 5.0×10⁻²%; non-glyceride esters of fatty acid, about 5.2×10⁻¹%.

Reference is made again to FIG. 2, presenting the synergistic effect of the oil blends as defined in the present invention, improving (by more than 43%) the stability to oxidation of blends of HOAC and nHOASB. Only a minor gain in stability is observed when a tocopherol blend is added to HOAC-nHOASB: specifically, addition of 0.07% and 0.13% tocopherols increases the blend's stability (i.e., increases the blend's induction time) by merely 6.2% and 7.5%, respectively. A significant and synergistic stabilization effect is provided by admixing the antioxidant water immiscible supplement as defined above. Here, addition of 0.07% and 0.13% of the supplement synergistically increases the oil blend's stability by the surprising amounts of 25% and more than 46%, respectively.

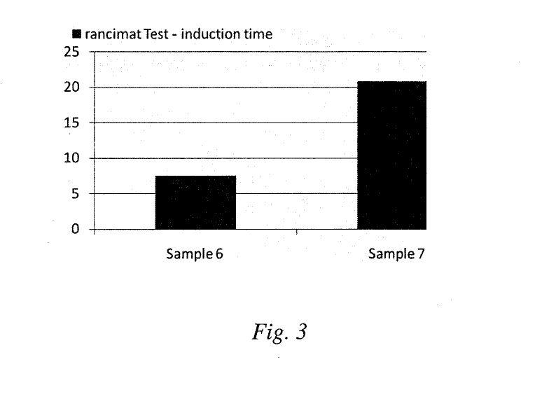

Reference is now made to FIG. 3, showing a highly effective oxidation-hindering effect of the oil blends as defined in the present invention. Two batches of HOA-blends (semi-preparative scale of about 1000 L each) were industrially prepared and tested to determine their oxidative stability as defined above.

Sample 6 is a HOAC-nHOASB blend, 20:80% with no antioxidant supplement. This light yellow oily liquid is characterized by a peroxide index of 0.70±0.1 mEq O₂/kg oil. Sample 7 comprises a HOAC-NHOASB blend, 20:80%, overall 99.4%, and 0.6% of a water immiscible antioxidant supplement. The aforesaid supplement consists of a mixture of isomers of tocopherol, namely α-tocopherol, about 1.2×10⁻²%; β+γ-tocopherol, about 3.6×10⁻²%; and δ-tocopherol, about 2.9×10⁻²%; sterols, about 4.5×10⁻²%; squalenes, about 1.5×10⁻³%; monoglycerides, about 2.6×10⁻²%; non-glyceride esters of fatty acids, about 2.4×10⁻¹%; Rosmarin extract, about 6.0×10⁻²%. The aforesaid HOAC-nHOASB blend is a light yellow oily clear liquid, characterized by peroxide index of 0.37±0.1 mEq O₂/kg oil, specific gravity of about 0.913 g cm⁻³, and viscosity of about 120 cP.

FIG. 3 clearly demonstrates both the cost-effectiveness and the efficiency of the blends disclosed in the present invention. Addition of 0.4% of an inexpensive supplement improves the stability to oxidation of the oil blend, which may be dominantly yet not exclusively commercially utilized as heavy-duty frying oil, by about 350% relative to a control soybean-based oil. Moreover, while the oil's stability to oxidation was remarkably increased, the organoleptic value and general appearance was not altered.

It is in the scope of the invention wherein an edible oil blend of improved oxidation stability is disclosed. The oil blend comprises about 79% refined and deodorized canola oil with about 20% high oleic sunflower oil in a refined and deodorized condition, the said high oleic sunflower oil having about a 80% or more oleic acid content, and further comprising about 0.4%-0.6% natural antioxidants.

It is further in the scope of the invention wherein an edible oil blend of improved oxidation stability is disclosed. The oil blend comprises about 79% refined and deodorized canola oil with about 20% high oleic sunflower oil in a refined and deodorized condition, the said high oleic sunflower oil having an about 80% or more oleic acid content, and further comprising about 0.4%-0.6% natural antioxidants and about 0.05-0.1% natural or synthetic emulsifiers.

It is also in the scope of the invention wherein additives are admixed to the oil blend as defined in any of the above. According to one embodiment, the additives are selected from synthetic antioxidants, and/or natural or synthetic emulsifiers. The antioxidant and/or natural or synthetic emulsifiers are added in an amount that does not affect the organoleptic characteristics of the oil blend, e.g., does not deteriorate its odor, flavor, taste or color.

According to one embodiment of the invention, the synthetic emulsifiers are selected, in a non-limiting manner, from a group consisting of phenolic compounds such as butylated hydroxyanisole (BHA), butylated hydroxytoluene (BHT), propyl gallate (PG) with and without ascorbyl palmitate (AP) and MGC etc. The synthetic emulsifiers may preferably, yet not exclusively, be selected from non-ionic emulsifiers, cationic emulsifiers, anionic emulsifiers and zwitterionic emulsifiers.

It is in the scope of the invention to disclose a method of refining edible oil as defined above. The method comprises unit operations selected from a group consisting of oil and blends refining by means of expelling and/or solvent extraction. The steps of refining usually utilizes caustic soda to convert these free fatty acids into sodium soaps which are then either removed by a centrifugal separator and water washing or otherwise removed by adsorption. The neutral oil is bleached by an adsorptive treatment followed by vacuum stripping process (deodorization). Alternatively, the method of refining comprises steps of acid degumming, bleaching and then vacuum stripping. It is further in the scope of the invention, wherein at least a portion of the HOA-nHOA blend and/or the antioxidants supplements as defined in any of the above is produced in a method comprising steps sleeted from, gas absorption, extraction and washing, distillation (e.g., short path distillation), crystallization, heating (e.g., high temperature short time techniques), membrane separations, drying and humidification, evaporation or any combination thereof.

1. An edible oil blend of improved oxidation stability, comprising up to 99.98% by weight of the total blend of a mixture of at least one high oleic oil (HOA) and at least one non-high oleic oil (nHOA), both of vegetable origin, and up to about 0.8% by weight of the total blend of a supplement of antioxidants of plant origin.

2. The edible oil blend of claim 1, wherein the antioxidant supplement comprises water-immiscible ingredients selected from a group consisting of at least one isomer of tocopherol, sterols, squalene, monoglycerides, non-glyceride esters of fatty acids, Rosemarin extract, rosmarinic acid and carnosic acid.

3. The edible oil blend of claim 1, comprising:
a. a mixture, comprising 90-99.98% by weight of the total blend, of at least one high oleic acid oil (HOA) and at least one non high oleic acid oil nHOA; said HOA to said nHOA weight ratio ranging from 60:40 to 90:10;
b. a mixture consisting at least one of the following isomers: α-tocopherol, α-Tocopherol, 1.5×10⁻³ to 7.5×10⁻²%; β+γ-Tocopherol, 0.4×10⁻²to 1.6×10⁻¹%; and, δ-Tocopherol, 0.35×10⁻²-1.4×10⁻¹%;
c. Sterols 0.5×10⁻² to 2×10⁻¹%;
d. Squalenes, 3×10⁻⁴ to 8×10⁻²%;
e. Monoglycerides, 3×10⁻³ to 1.5×10⁻¹%;
f. Non-glycerid esters of fatty acids 2×10⁻² to 0.9%; and,
g. Optionally, Rosmarin extract 0.7×10⁻² to 3×10⁻¹%.

4. The edible oil blend of claim 1 characterized by an induction time of more than 20 hours as determined by the Rancimat Test (ISO 6886) at 110° C., air flow of 20 L h⁻¹, and conductivity range of 200 μS.

5. The edible oil blend according to claim 1, wherein said at least one HOA is selected from a group consisting of high oleic soya oil, high oleic rapeseed oil, high oleic safflower oil, and any other high oleic oils from high oleic varieties of vegetables or plants or other oils of vegetable or plant origin naturally containing at least 70% oleic acid or any mixtures thereof.

6. The edible oil blend according to claim 1, wherein the said non-HOA is selected from a group of edible oils with a low oleic acid content, said oils comprising saturated fatty acids selected from a group of isopropanoic, butanoic, isobutanoic, pentanoic, isopentanoic, neopentanoic, isohexanoic, 2-ethylbutanoic, heptanoic, 2-methylhexanoic, isoheptanoic, neoheptanoic, octanoic, isooctanoic, 2-ethylhexanoic, nonanoic, isononanoic, 3,5,5,-trimethylhexanoic, decanoic, isodecanoic, neodecanoic, myristic, margaric, stearic, isostearic, linoleic, linolenic, nonadecanoic, erucic, behenic acids and mixtures thereof; dicarboxylic acids selected from succinic, glutaric, adipic, sebacic, phthalic, isophthalic and terephthalic acids, isomers thereof and/or any mixtures thereof; mono unsaturated acids (MUFAs), selected from a group of palmitoleic acid, cis-vaccenic acid, and oleic acid; polyunsaturated fatty acids (PUFAs), selected from a group of Omega-3 fatty acids, including alpha-linolenic acid, Stearidonic acid, Eicosatrienoic acid, Eicosapentaenoic, Eicosapentaenoic acid, Docosapentaenoic acid, Tetracosapentaenoic acid, Tetracosahexaenoic acid etc., Omega-6 fatty acids including Linoleic acid, Gamma-linolenic acid, Eicosadienoic acid, Dihomo-gamma-linolenic acid, Arachidonic acid, Docosadienoic acid, Adrenic acid, Docosapentaenoic acid etc., and/or Omega-9 fatty acids selected from monosaturated acids, including Eicosenoic acid, Erucic acid, Nervonic acid and polyunstaurated acids including Mead acid.

7. The edible oil blend according to claim 1, wherein said at least one isomer of tocopherol is selected from a group consisting of α-tocopherol, β-tocopherol, γ-tocopherol, δ-tocopherol, α-tocotrienol, β-tocotrienol, γ-tocotrienol, δ-tocotrienol, or any mixtures thereof.

8. The edible oil blend according to claim 1, wherein said sterols are phytosterols selected from a group consisting of α-sitosterol, γ-sitosterol, β-sitosterol, campesterol, stigmasterol, brassicasterol, spinosterol, taraxasterol, desmosterol, chalinosterol, poriferasterol, c\ddot{υ}onasterol, ergosterol, Δ-5 avenosterol, campesterol Δ-5-campesteroi, cierosterol, Δ-5-stigmasterol, Δ-7, 25-stigmadienol, Δ-7-avenosterol, Δ-7-β-sitosterol, brassicasterol, Δ-7-brassicasterol or any mixtures thereof.

9. The edible oil blend according to claim 11, wherein said monoglycerides are admixed with diglycerides.

10. The edible oil blend according to claim 1, further comprising compositions selected from a group consisting of propylene glycol, triacetine, carotenes, especially β-carotente, vitamin A, glutamine, flavor and fragrance compositions, surfactants or any mixtures thereof.

11. A frying oil blend as defined in claim 1, characterized by high induction time of more than 20 hours according to the Rancimat Test ISO 6886.

12. A method of increasing the induction time of oils, comprising the steps of
a. obtaining an edible oil mixture comprising:
i. at least one high oleic acid oil (HOA) of vegetable source; and,
ii. at least one non-high oleic acid oil (nHOA) of vegetable source, said HOA and nHOA being admixed in a weight ratio ranging from 10:90 to 30:70, preferably 20:80; and,
b. admixing said mixture with an antioxidant supplement in a ratio of up to about 99:1 (oil blend: antioxidant by weight).

13. The method of claim 12, wherein said step of admixing said mixture with said antioxidant supplement additionally comprises a step or steps of admixing water-immiscible ingredients selected from a group consisting at least one isomer of Tocopherol, sterols, squalene, monoglycerides, non-glyceride esters of fatty acids and Rosmarin extract; thereby increasing the induction time of oils more than 20 hours as determined by the Rancimat Test.

14. The method according to claim 12, additionally comprising step of selecting said at least one HOA from a group consisting of high oleic soya oil, high oleic rapeseed oil, high oleic safflower oil, and any other high oleic oils from high oleic varieties of vegetables or plants or other oils of vegetable or plant origin naturally containing at least 70% oleic acid or any mixtures thereof.

15. The method according to claim 18, additionally comprising step of selecting said non-HOA oils to be edible oils with a low oleic acid content, said oils comprising fatty acids selected from a group consisting of saturated fatty acids other than oleic acid, especially organoleptically acceptable edible oils comprising saturated fatty acids selected from a group of isopropanoic, butanoic, isobutanoic, pentanoic, isopentanoic, neopentanoic, isohexanoic, 2-ethylbutanoic, heptanoic, 2-methylhexanoic, isoheptanoic, neoheptanoic, octanoic, isooctanoic, 2-ethylhexanoic, nonanoic, isononanoic, 3,5,5,-trimethylhexanoic, decanoic, isodecanoic, neodecanoic, myristic, margaric, stearic, isostearic, linoleic, linolenic, nonadecanoic, erucic, behenic acids and mixtures thereof; dicarboxylic acids selected from succinic, glutaric, adipic, sebacic, phthalic, isophthalic and terephthalic acids, isomers thereof and/or any mixtures thereof; ; mono unsaturated acids (MUFAs), selected from a group of palmitoleic acid, cis-vaccenic acid, and oleic acid; polyunsaturated fatty acids (PUFAs), selected from a group of Omega-3 fatty acids, including alpha-linolenic acid, Stearidonic acid, Eicosatrienoic acid, Eicosapentaenoic, Eicosapentaenoic acid, Docosapentaenoic acid, Tetracosapentaenoic acid, Tetracosahexaenoic acid etc., Omega-6 fatty acids including Linoleic acid, Gamma-linolenic acid, Eicosadienoic acid, Dihomo-gamma-linolenic acid, Arachidonic acid, Docosadienoic acid, Adrenic acid, Docosapentaenoic acid etc., and/or Omega-9 fatty acids selected from monosaturated acids, including Eicosenoic acid, Erucic acid, Nervonic acid and polyunstaurated acids including Mead acid.

16. The method according to claim 12, additionally comprising step of selecting said at least one isomer of Tocopherol from a group consisting of α-Tocopherol, β-Tocopherol, γ-Tocopherol, δ-Tocopherol, α-Tocotrienol, β-Tocotrienol, γ-Tocotrienol, δ-Tocotrienol, or any mixtures thereof.

17. The method according to claim 12, additionally comprising step of selecting said sterols to be phytosterols selected from a group consisting of α-sitosterol, γ-sitosterol, β-sitosterol, campesterol, stigmasterol, brassicasterol, spinosterol, taraxasterol, desmosterol, chalinosterol, poriferasterol, c\ddot{υ}onasterol, ergosterol, Δ-5 avenosterol, campesterol Δ-5-campesteroi, cierosterol, Δ-5-stigmasterol, Δ-7, 25-stigmadienol, Δ-7-avenosterol, Δ-7-β-sitosterol, brassicasterol, Δ-7-brassicasterol or any mixtures thereof.

18. The method according to claim 12, additionally comprising step of selecting said squalene to be 2,6,10,15,19,23-hexamethyl-tetracosahex-2,6,10,14,18,22-ene or derivative thereof.

19. The method according to claim 12, additionally comprising step of selecting said Monoglycerides to be mixtures of monoglycerides and diglycerides.

20. The method according to claim 12, additionally comprising steps of (c) selecting at least one composition from a group consisting of propylene glycol, triacetine, carotenes, especially β-carotene, vitamin A, glutamine, flavor and fragrance compositions, surfactants or any mixtures thereof, and (d) admixing the selected food additive to the oil blend.
